(19) United States
(12) Patent Application Publication
(10) Pub. No.: US 2006/0254066 A1
(43) Pub. Date: Nov. 16, 2006

(54) Level-determining adhesive patch

(76) Inventor: Yoel Lang, Givataim (IL)

Correspondence Address: NIXON & VANDERHYE, PC, 901 NORTH GLEBE ROAD, 11TH FLOOR, ARLINGTON, VA, 22203, US

(21) Appl. No.: 10/538,043

(22) PCT Filed: Dec. 10, 2003
(86) PCT No.: PCT/IL03/01046

§ 371 Date: Dec. 21, 2005

(30) Foreign Application Priority Data
Dec. 12, 2002 (IL) 153400

(51) Int. Cl. G01C 9/00

(52) U.S. Cl. 33/371

(57) ABSTRACT

An adhesive patch containing an integral spirit level, said adhesive patch comprising: a) a first transparent film comprising an indented region; b) a second film, having an upper surface that is attached to the lower surface of said first transparent film, such that the indented region of said first film and the portion of said second film that lies immediately below said indented region together define a closed tubular structure; c) level-indicating means associated with said tubular structure; and d) adhesive means for affixing the patch to a surface whose orientation is to be determined; wherein the level-indicating means provide an indication of the spatial orientation of the surface to which said adhesive patch is affixed.

### FIELD OF THE INVENTION

The present invention relates to a level-determining device. More specifically, the present invention relates to an adhesive patch containing an integral spirit level.

### BACKGROUND OF THE INVENTION

The use of spirit levels and other related leveling devices (such as clinometers) in a variety of engineering and domestic settings is well known in the art. In its most usual form, the spirit level consists of a rigid-walled, transparent capsule partially filled with a liquid, into which is entrapped a bubble. By means of suitable markings placed either on the capsule itself or on a base member supporting said capsule, the user is able to determine when the device is placed in a level orientation in relation to a desired plane.

Most prior-art spirit levels are constructed using fluid-filled sealed glass or machined plastic capsules mounted on a rigid supporting member. One consequence of this traditional design is that the devices are delicate, expensive to construct and bulky. Moreover, many such devices need to be hand-held while in use, thus rendering them unsuitable for applications requiring indwelling spirit levels.

A need exists for an accurate, inexpensive spirit level of simple construction that may be readily secured to a surface.

A partial solution to this problem was presented in U.S. Pat. No. 4,100,681 which discloses a picture-leveling device in the form of a transparent tape having partially fluid filled blister-like cavities. The underside of this device is fitted with an adhesive tape to permit said device to be attached to the surface of a picture frame, whose level is to be checked. One significant drawback to this prior art solution is the limited accuracy of the device. Furthermore, the fluid bubble is difficult to read and very hard to manufacture as the air bubble may vary in size during mass-production.

The aim of the present invention, which will shortly be disclosed and described hereinbelow, is to provide an inexpensive level-determining device that is equipped with adhesive means for applying said device to the surface whose level is to be checked.

A further aim of the present invention is to provide an adhesive spirit level which may be used to accurately determine the spatial orientation of any plane of an object.

Yet another aim of the present invention is to provide an adhesive spirit level device that overcomes the disadvantages of prior art devices.

Further advantages and objectives of the present invention will become clear as the description proceeds.

### SUMMARY OF THE INVENTION

It has now been unexpectedly found that it is possible to construct an adhesive patch into which has been incorporated a low-profile spirit level of tubular design. The ease of construction and range of polymeric and metallic materials that may be used makes it possible to produce a large range of different shaped adhesive spirit level devices suitable for a variety of applications, on an industrial scale.

The term “spirit level” as used hereinabove and hereinbelow is used to indicate any suitable device that may be used for determining whether a surface upon which said device rests, or to which said device is affixed, is level. Despite the fact that the “spirit levels” of the present invention are not limited to devices containing “spirit”, (for example, alcohols or alcohol mixtures such as used in most earlier devices that are described by this term), this term is retained for reasons of convention and convenience of description, and is to be understood as being interchangeable with the term “level-determining device”.

The present invention is primarily directed to an adhesive patch containing an integral spirit level, said adhesive patch comprising:
a) a first transparent film comprising an indented region;
b) a second film, having an upper surface that is attached to the lower surface of said first transparent film, such that the indented region of said first film and the portion of said second film that lies immediately below said indented region together define a closed tubular structure;
c) level-indicating means associated with said tubular structure; and
d) adhesive means for affixing the patch to a surface whose orientation is to be determined;
wherein the level-indicating means provide an indication of the spatial orientation of the surface to which said adhesive patch is affixed.

In a particularly preferred embodiment of the invention, the aforementioned level-indicating means comprises:
i) pre-calibrated markings located either on the closed tubular structure or on the upper surface of the first transparent film alongside said tubular structure; and
ii) at least one visible indicator located within said closed tubular structure, wherein said visible indicator is either a sphere or is chosen from the group consisting of gas-liquid interface, liquid-liquid interface and gas-gas interface,
such that rotation of the surface to which said adhesive patch is affixed causes relative movement of said visible indicator(s) and said pre-calibrated markings.

All the above and other characteristics and advantages of the present invention will be further understood from the following illustrative and non-limitative examples of preferred embodiments thereof.

### BRIEF DESCRIPTION OF THE DRAWINGS

FIG. 1 depicts one general embodiment of the device of the invention. In the version of the embodiment shown in FIGS. 1A and 1B, the adhesive surface is attached to the left side of the patch, whiles FIGS. 1C and 1D depict a different version having the adhesive surface adjoining the inferior side of the patch. FIGS. 1A and 1C show the patch in a horizontal orientation, while FIGS. 1B and 1C illustrate the effect of rotating said patch by 20 degrees. The location of the adhesive means is indicated by hatching.

FIG. 2 illustrates another embodiment of the device of the invention, wherein the tubular structure is curved and the level-indicating means is provided by a sphere that may move freely within the fluid contents (or partial vacuum) present in said tubular structure. Various versions of this embodiment, wherein the tubular structure contains a gas (or is partially evacuated), a liquid or combination of liquid and gas, are depicted in FIGS. 2A, 2B and 2C, respectively. While the sphere shown in each of these figures is denser than the fluid contained within the tubular structure, FIG. 2D shows a version of this embodiment, wherein the sphere is less dense than said fluid.

### DETAILED DESCRIPTION OF PREFERRED EMBODIMENTS

The device of the present invention may be conveniently manufactured in several different embodiments and conformations. Thus, with respect to the spirit level element, the closed tubular structure may be constructed in any convenient shape. In one preferred embodiment, for example, the tubular structure is linear in shape. In another preferred embodiment, said tube is provided in an annular form. In yet further preferred embodiments, the tube may be either curved or U-shaped. In other embodiments, the tubular structure may also contain expanded or narrowed sections at various points along its length.

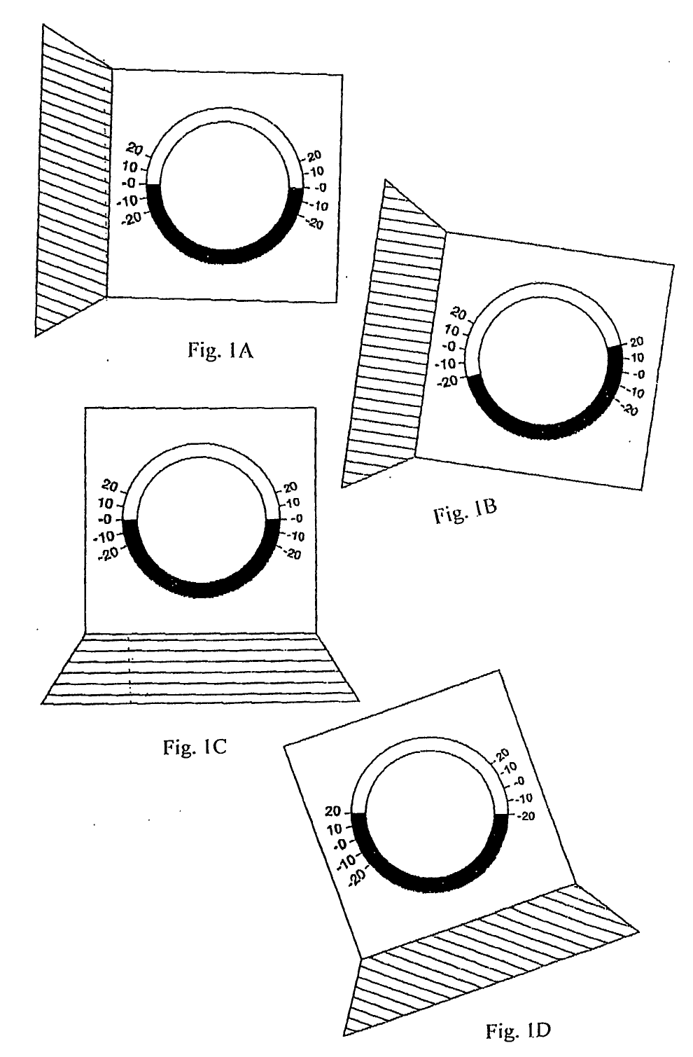

The level-indicating means of the presently claimed device may be of several different types, employing a variety of physical principles. In one embodiment, the level-indicating means comprises markings placed on or adjacent to two regions of the closed tubular structure, said structure being partially filled with a fluid. The fluid that is contained within the tubular structure may be either a gas (such as air, oxygen, nitrogen, helium etc.) or a liquid (such as water, colored water, colored emulsions, phosphorescent solutions, fluorescent solutions, alcohols such as methanol, ethanol or propanol, organic compounds such as turpentine, petrol, oil, polar liquids, phenols, non-polar liquids, liquids containing detergents or other surfactants or light reflective liquids). In one particularly preferred embodiment (as depicted in FIG. 1) the tubular structure is annular in shape, and is partially filled with a colored liquid. The rest of the internal volume of said structure contains air that was trapped inside the tube during the process of manufacture (as will be described hereinbelow). In addition, left- and right-side calibrated markings are formed on the upper surface of the first film, adjacent to said tubular structure, said markings being arranged such that when the device is in a level orientation, the two liquid-air interfaces are located opposite the left- and right-side zero markings. When the device is rotated, the liquid remains essentially stationary in relation to an imaginary horizontal plane, due to the equal pressures exerted by the entrapped air on each of the air-liquid interfaces. However, due to the rotation of the tubular structure and its associated calibrated markings, the aforementioned liquid-air interfaces will now be situated alongside different calibrated markings (i.e., not alongside the zero markings). In a particularly preferred embodiment (as shown in FIG. 1) the markings are pre-calibrated in order to provide an indication of the angle through which the device of the invention has been rotated.

In a further preferred embodiment, the closed tubular structure contains air, and the level-indicating means comprise (in addition to the pre-calibrated markings) by a drop of liquid (e.g. colored water or alcohol) that is free to move within said air in response to rotational displacement of the device, the orientation of said device being indicated by markings present on or alongside said tubular structure.

In a further preferred embodiment of the device of the invention, the closed tubular structure is partially filled with a colored liquid, the level indicating means being represented by a second liquid that fills all or most of the remaining space within the tube, said second liquid being of a different color from the first liquid and also being immiscible therewith. Upon rotation of the device, the markings made on or alongside the closed tubular structure rotate relative to the liquid-liquid interface(s). As mentioned hereinabove, any two differently-colored and mutually immiscible liquids may be used, including (but not limited to) water, colored water, colored emulsions, phosphorescent solutions, fluorescent solutions, alcohols such as methanol, ethanol or propanol, organic compounds such as turpentine, petrol, oil, polar liquids, phenols, non-polar liquids, liquids containing detergents or other surfactants and light reflective liquids.

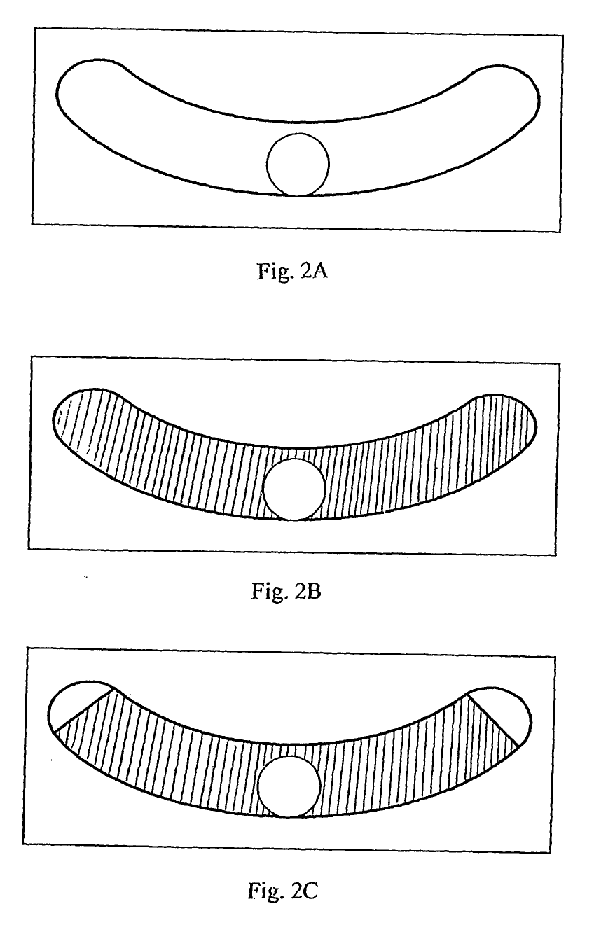

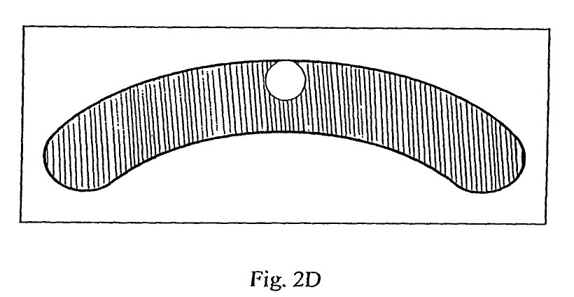

In yet a further preferred embodiment, the level-indicating means are provided by a sphere (such as a ball bearing) that is capable of movement along the tubular structure, said structure being filled with either a dense liquid or a dense gas, such as air, said sphere being either less dense or denser than said liquid or said gas. In those embodiments that utilize spheres as part of the level-indicating means, the closed tubular structure is required to be either circular, U-shaped or otherwise curved in shape. Preferably, the sphere is slightly smaller in diameter than the internal diameter of the tube, such that the linear movement of said sphere is unhindered by either frictional resistance imposed by the internal walls of said tube or by non-axial reflection of the sphere off said internal walls. The sphere may be constructed of any suitable material including, but not limited to, iron, steel, porcelain, glass, synthetic polymers and ceramic materials. FIG. 2 pictorially represents several different versions of this embodiment of the invention. Thus, FIG. 2A depicts a device according to the present invention comprising a curved tubular structure containing a sphere, as described hereinabove. In this particular embodiment, the remaining internal space of said curved tubular structure is either filled with a gas such as air, or contains a partial vacuum. In the embodiment shown in FIG. 2B, the curved tubular structure contains, in addition to the sphere, a liquid, such as air or an alcohol (indicated by shading). FIG. 2C depicts a similar embodiment to that shown in FIG. 2B, with the exception that the tubular structure contains a gas, such as air or a component thereof, in addition to the sphere and the liquid. In all of the embodiments depicted in FIGS. 2A-2C, the sphere is denser than the fluid(s) that fill the remaining internal space within the curved tube. In contradistinction, FIG. 2D depicts an embodiment wherein the sphere is less dense than the fluid contents of the curved tube.

In most embodiments of the invention, the closed tubular structure will have markings on or alongside its surface to indicate the desired (generally, horizontal) position. In other embodiments, said markings will be placed such that they provide an indication of when the device of the invention is placed in an exactly vertical orientation. In a particularly preferred embodiment, further, pre-calibrated angular markings indicating the degree of rotation will also be present alongside or on the surface of the closed tubular structure.

In one preferred embodiment of the invention, the first film is constructed of a transparent, synthetic polymer. Although any such suitable polymer may be used to construct the first film, particularly preferred materials include polypropylene, polyethylene, polyester, polyteraphtalate, polycarbonate, polyvinyl chloride and combinations of said materials, either as mixtures or as distinct bilayered or multilayered structures.

The purpose of the second film is to provide the posterior wall of the tube, and further to permit affixation of the device of the invention onto a surface of the object whose level is to be checked. In one preferred embodiment, the second film may be constructed of a transparent polymer similar to the abovementioned examples of materials used in the construction of the first film. In another preferred embodiment, the second film may comprise an opaque material in order to provide better contrast between the liquid height and the level-determining markings of the device. In this case the second film may be a metal film or a multilayered film of metal and plastic.

Either the first film or the second film or, alternatively, both films, may be coated with an adhesive to promote bonding between the two films.

Use of the Device

Typically, the device of the invention is used to determine whether a picture-frame has been hung in a level manner, that is, with the top surface of said frame in a plane approximately parallel to the floor and/or ceiling. In such a case, the device may be affixed to the front surface of the frame such that the essentially horizontal edges of said device are parallel to the essentially horizontal upper and/or lower edge of said frame, the adhesive portion thereof being pressed firmly onto the frame in order to ensure that the device is immobilized in relation to the picture-frame. Alternatively, the device of the invention may be affixed to the upper surface of the picture-frame in a similar way.

As mentioned hereinabove, the first film may be equipped with pre-calibrated markings on its upper surface, the purpose of which is to provide a quantitative measure of the degree of tilt of a non-level object. The use of such a calibrated device is illustrated in FIG. 1. Thus, if a device according to the present invention is adhered to an object placed in a horizontal position (FIGS. 1A and 1C), the upper levels of the fluid contained within the annular tube depicted therein coincides with the zero markings that are located on the upper surface of the first film. When the device is tilted by 20 degrees in a clockwise direction, the upper levels of the fluid then become coincident with the 20 degree markings (FIG. 1B). FIG. 1D similarly illustrates the situation wherein the device is rotated by 20 degrees in an anti-clockwise direction.

Finally, it should be noted that the device of the invention is not limited in its applicability to picture-hanging. Rather, it may be used in any circumstance in which the spatial orientation of an article or object is required to be determined. Many such applications are to be found in the building trades including, for example, the erection of pre-constructed (e.g. plasterboard) walls.

Manufacture of the Device

One embodiment of the device of the present invention may be conveniently manufactured in the following manner:

1. An indent of the desired shape (e.g. annular, U-shaped, linear etc.) is formed in an optically clear film such as polyester having a thickness of about 50-250 micrometer. Such indents may be formed by any suitable means, but are preferably created by use of a vacuum-forming technique, or by placing the film over a solid former of the desired shape, heating the film to about 180° C. and applying pressure to the film in order to create the negative counterpart of said solid former on the film. Any other suitable die-forming or pressure-forming technique employing suitable mandrels or coining or embossing tools may also be used.

2. The first film containing the indented structure is placed horizontally and the indent is then partially filled with a spirit or suitable solution, including (but not restricted to) water, colored water, colored emulsions, phosphorescent solutions, fluorescent solutions, alcohols such as methanol, ethanol or propanol, organic compounds such as turpentine, petrol, oil, polar liquids, phenols, non-polar liquids, liquids containing detergents or other surfactants and light reflective liquids.

3. A second (polymeric or metallic) film is then heat laminated or adhered to the indented clear film thus locking in the solution. Suitable level markings are then added to the upper surface of the first film.

4. Pressure-sensitive adhesive is applied to the under-surface of the second film, either to across the entire area of said second film, or to selected regions thereof. Optionally, suitable folding lines may be created on the second film, such that an adhesive-coated portion of the device of the invention may be folded in order that said portion becomes orientated at angle (preferably, but not limited to, 90 degrees) to the level-determining structure. Such an embodiment is useful in circumstances wherein there is a need to avoid contacting a decorative surface, for example a painting or decorative frame thereof, with adhesive. In such a case, the adhesive-coated portion of the device may be affixed to the upper surface of the picture frame, and the device folded at the desired angle (usually, but not limited to, 90 degrees) such that the level-determining structure may be read from the front of the painting.

5. Markings representing the level position and various pre-determined rotational angles therefrom are made either on the surface of the tubular structure, or alongside said tubular structure on the upper surface of the first transparent film. These markings may be made by any suitable technique known in the art, including (but not limited to) engraving, etching, and application of black, colored or fluorescent transfers.

In a modification of the above-described procedure, one may completely fill the indent described above with two immiscible liquids of similar or different colors.

In the case of yet another preferred embodiment of the invention, a sphere may be placed inside the indented portion of the first film described in step 1, above. At the same time as the sphere is placed inside said indented portion, a liquid or combination of liquid and gas may also be inserted therein.

While specific embodiments of the invention have been described for the purpose of illustration, it will be understood that the invention may be carried out in practice by skilled persons with many modifications, variations and adaptations, without departing from its spirit or exceeding the scope of the claims.

1. An adhesive patch containing an integral spirit level, said adhesive patch comprising:
a) a first transparent film comprising an indented region;
b) a second film, having an upper surface that is attached to the lower surface of said first transparent film, such that the indented region of said first film and the portion of said second film that lies immediately below said indented region together define a closed tubular structure;
c) level-indicating means associated with said tubular structure; and
d) adhesive means for affixing the patch to a surface whose orientation is to be determined;
wherein the level-indicating means provide an indication of the spatial orientation of the surface to which said adhesive patch is affixed.

2. The adhesive patch according to claim 1, wherein the level-indicating means comprises:
i) pre-calibrated markings located either on the closed tubular structure or on the upper surface of the first transparent film alongside said tubular structure; and
ii) at least one visible indicator located within said closed tubular structure, wherein said visible indicator is either a sphere or is chosen from the group consisting of gas-liquid interface, liquid-liquid interface and gas-gas interface,
wherein rotation of the surface to which said adhesive patch is affixed causes relative movement of said visible indicator(s) and said calibrated markings.

3. The adhesive patch according to claim 2, wherein the closed tubular structure is provided in an annular shape.

4. The adhesive patch according to claim 3, wherein the annular closed tubular structure is partially filled with a colored liquid, and wherein the visible indicators are provided by the two air-colored liquid interfaces present within said closed tubular structure, such that upon rotation of said patch, the pre-calibrated markings move relative to said interfaces.

5. The adhesive patch according to claim 4, wherein the colored liquid comprises a fluorescent material.

6. The adhesive patch according to claim 4, wherein the liquid comprises a light-reflective material.

7. The adhesive patch according to claim 2, wherein the closed tubular structure is provided in a curved shape.

8. The adhesive patch according to claim 7, wherein the curved tubular structure contains either a liquid or a liquid and a gas, and wherein the visible indicator is provided by a sphere, such that upon rotation of said patch, the pre-calibrated markings move relative to said sphere.

9. The adhesive patch according to claim 2, wherein the closed tubular structure is essentially straight.

10. The adhesive patch according to claim 1, wherein the pre-calibrated markings are fluorescent markings.
